(19) United States
(12) Patent Application Publication
(10) Pub. No.: US 2010/0116301 A1
(43) Pub. Date: May 13, 2010

(54) TOP SPRAY DEVICE FOR DISHWASHERS

(75) Inventors: Bernd Heisele, Sontheim (DE); Anton Oblinger, Wertingen (DE); Karlheinz Rehm, Dischingen Ortst. Trugenhofen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, München (DE)

(21) Appl. No.: 12/593,641

(22) PCT Filed: Mar. 31, 2008
(86) PCT No.: PCT/EP2008/053828

§ 371 Date: Sep. 29, 2009

(30) Foreign Application Priority Data
Apr. 11, 2007 (DE) 10 2007 017 114.7

(51) Int. Cl. B08B 3/00

(52) U.S. Cl. 134/172

(57) ABSTRACT

A dishwasher is provided that includes a hydraulic system and a top spray device that is disposed above a washing product basket such as a cutlery drawer. The top spray device can be supplied with a washing solution via the hydraulic system and has a rotatable spray head that is attached to the hydraulic system via a cage.

The invention relates to a dishwasher, in particular a domestic dishwasher in accordance with the preamble of claim 1.

A dishwasher is known from EP 1 382 287 A2, which has a top spray device which can be supplied with washing solution by way of the line system in the dishwasher. In this situation, the top spray device is arranged centrally in the center of the top of the washing compartment. The top spray device has a rotatably mounted spray head which is attached to a water conduit by means of a clip. The water line has an opening, through which the spray head can be supplied with spray solution, which then exits through a plurality of spray openings in the spray head and in doing so causes the spray head to rotate such that an even distribution of the washing solution over the items to be cleaned is ensured. There is however a danger of soilings accumulating in the area of the rotatable mounting of the spray head, in particular in the area of the connecting pieces encroaching into the spray head, such that the reliable operation of the top spray system is not guaranteed.

The object of the invention is therefore to provide a remedy here.

The object of the invention is achieved by a dishwasher, in particular a domestic dishwasher, comprising a hydraulic system and at least one top spray device arranged above at least one basket for items to be washed, in particular a basket for items to be washed taking the form of a cutlery drawer, which can be supplied with washing solution by means of the hydraulic system, and which has a rotatable spray head which is attached to the hydraulic system by means of a cage, characterized in that the spray head can be supplied with washing solution by way of a free path. As a result of supplying the spray head by way of a free path, it is possible to considerably increase the reliability of the top spray device because it thus becomes possible to dispense with a shaft connection between spray head and hydraulic system, in the area of which soilings can easily accumulate. In addition, the construction and the assembly are simplified because there is no longer a requirement for a water-bearing shaft connection between rotatable spray head and hydraulic system.

Provision is preferably made such that the spray head is rotatably mounted in the cage, in other words there is no shaft connection between spray head and lines belonging to the hydraulic system. This enables the rotatable mounting of the spray head to be arranged in an area in which only a low level of soiling by washing solution is to be reckoned with, for example an area on the underside of the rotatable spray head, in other words on the side which faces away from the top of the washing compartment and faces the base of the washing compartment.

Provision is preferably made such that the cage has a shaft journal engaging in a seat in the spray head. It is however also possible for the spray head to have a shaft journal which engages in a seat in the cage.

Provision is preferably made such that the spray head has a central deflector surface. The central deflector surface forms the end of the free path which is arranged with an outlet at an end section of a line belonging to the hydraulic system. The spray head has a turbine wheel shaped design, wherein a plurality of guide elements form a plurality of channels, through which washing solution can be evenly distributed during operation onto items including cutlery to be washed to act thereon.

In this situation, provision is preferably made such that the central deflector surface is implemented in order to direct washing solution into the channels so as to ensure that the washing solution is directed essentially loss-free from the free path by way of the central deflector surface into the channels and finally to the items including cutlery to be washed to act thereon.

To this end, the central deflector surface can exhibit any desired suitable form. Provision is preferably made such that the central deflector surface is implemented to be essentially conical in shape. This allows a particularly advantageous implementation of the spray head to be realized, wherein the conically implemented central deflector surface is arranged with its apex in the direction of the top of the spray compartment, whereby in the interior of the conically implemented deflector surface a seat for a shaft journal is formed in the cage, in other words such that the seat is arranged opening in the direction of the base of the washing compartment.

In addition, provision is preferably made such that the spray head is implemented to be essentially rotationally symmetrical, in other words it essentially has a turbine wheel like shape with an essentially constant diameter and radius. This permits a compact type of construction and problem-free incorporation in a cage likewise implemented to be essentially rotationally symmetrical.

Furthermore, provision is preferably made such that the cage is attached to the hydraulic system by means of a snap-action connection. To this end, at two sides situated opposite one another the cage has two elastically deflectable snap-action elements which in the mounted state engage in corresponding recesses in the end section of a line belonging to the hydraulic system, such that problem-free assembly and where applicable disassembly is possible in order to be able to carry out cleaning work when required.

In addition, a top spray device for incorporation in a dishwasher and also a spray head and a cage for forming a spray device of this type belong to the invention.

The invention will be described in the following with reference to a drawing. In the drawings:

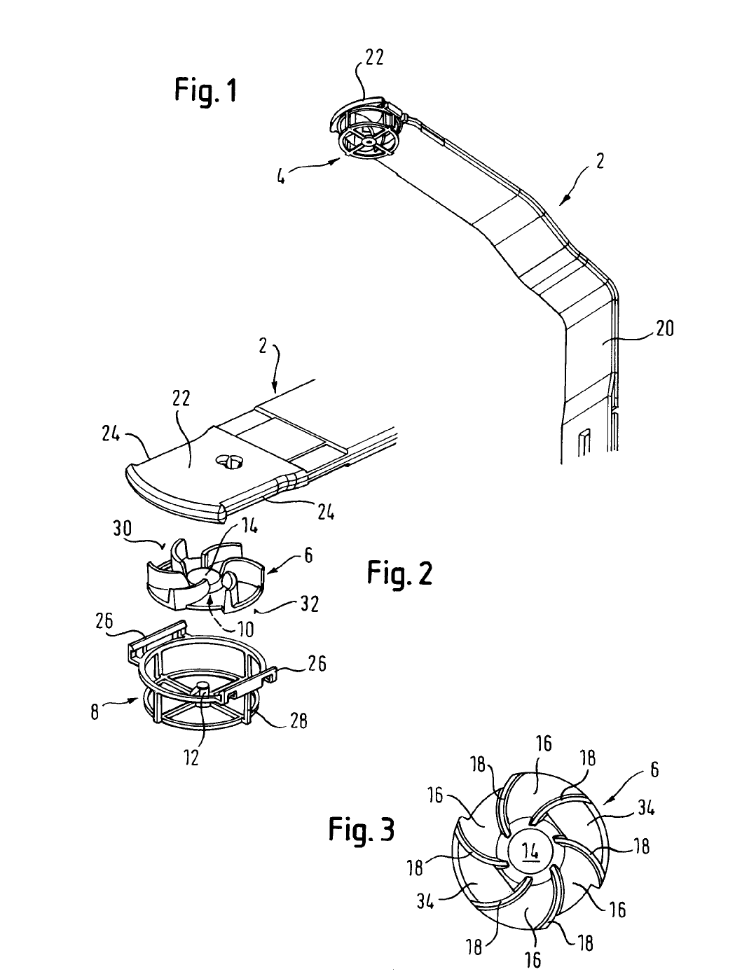

FIG. 1: shows a schematic representation of a top spray device according to the invention on a line,

FIG. 2: shows an exploded view of a top spray device according to the invention with a line section, and

FIG. 3: shows a top view of a schematic representation of a spray head according to the invention.

Illustrated is a line 20, belonging to the hydraulic system 2 of the dishwasher, which can be implemented to have a plurality of channels on a single level and, through a connection with the circulating pump, serves to supply the spray arms for applying washing solution to the items to be washed.

A top spray device 4 is arranged on an end section 22 of the line 20. In this situation, the line 20 is dimensioned such that the end section 22 with the top spray device 4 is arranged centrally in the top area of the washing compartment and can be used for example to evenly apply washing solution to a basket for items to be washed implemented as a cutlery drawer.

The top spray device comprises a rotatable spray head 6 and a retaining element implemented as a cage 8. Both the spray head 6 and also the cage 8 are manufactured from a plastic material which is selected in accordance with the conditions in the interior of a dishwasher, in other words which in particular is appropriately resistant to temperature and chemicals.

The rotatable spray head 6 has a turbine wheel like shape and is therefore implemented to be essentially rotationally symmetrical with an essentially constant diameter and radius. The upper side 30 of the spray head 6 has a plurality of guide elements 18 which form channels, running radially outwards. Centrally in the center of the spray head 6 is arranged a deflector surface 14 which is implemented to rise conically from the upper side 30 such that washing solution striking the central deflector surface 14 is guided by the conical shape in conjunction with the guide elements 18 through the channels 16 to the edge of the spray head 6. In addition, two cutouts 34 are provided, by means of which washing solution can be deflected not in the radial direction but can pass directly downwards, in other words in the direction of the base of the washing compartment, with the result that areas arranged directly beneath the spray head 6 are also supplied with washing solution.

The underside 32 of the spray head 6 has a seat which extends into the interior of the conically configured deflector surface from beneath and is implemented to accommodate a shaft journal 12 belonging to the cage 8.

The cage 8 has an essentially likewise rotationally symmetrical shape with constant radius and diameter; the cage 8 comprises a grid structure 28 which has in a central position the shaft journal 12 which engages in the seat in the spray head 6. In order to attach the cage (8), at an end section 22 of the line 20 two snap-action elements 26, which are implemented to be elastically deflectable, are arranged at two opposite positions on the grid structure 28 and thus make it possible during assembly to mount the cage 8 with a spray head 6 incorporated by deflecting it and engaging it in corresponding recesses 24 on the end section 22 of a line 20.

During operation, washing solution passes out of an opening (not shown) arranged in the end section 22 of the line 20, which solution after overcoming a free path (not shown) strikes the conically implemented central deflector surface 14, from which the washing solution is directed into the channels 16 formed by the guide elements 18, which on account of their shape cause the spray head 6 to rotate and the washing solution thus passes out from the channels 16 and applies washing solution to the items to be washed arranged beneath the top spray device 4. In addition, washing solution passes directly through the cutouts 24 and thus reaches areas directly beneath the spray head 6, with the result that washing solution can also be applied to items to be washed and cutlery located in this area.

### LIST OF REFERENCE CHARACTERS

2 Hydraulic system
4 Top spray device
6 Spray head
8 Cage
10 Seat
12 Shaft journal
14 Deflector surface
16 Channel
18 Guide element
20 Line
22 End section
24 Recess
26 Snap-action element
28 Grid structure
30 Upper
32 Underside
34 Cutout

1-11. (canceled)

12. A dishwasher, in particular a domestic dishwasher, the dishwasher comprising:
a hydraulic system;
a basket for items to be washed, in particular, a basket in the form of a cutlery drawer; and
at least one top spray device arranged above the basket for items to be washed, the at least one top spray device being operable to receive washing solution via the hydraulic system and having a rotatable spray head and a retaining element for attaching the spray head to the hydraulic system, and the spray head being operable to receive washing solution supplied thereto via a free path.

13. The dishwasher as claimed in claim 12, wherein the spray head is rotatably mounted on the retaining element.

14. The dishwasher as claimed in claim 13, wherein the retaining element has a shaft journal engaging in a seat in the spray head.

15. The dishwasher as claimed in claim 12, wherein the spray head has a central deflector surface.

16. The dishwasher as claimed in claim 15, wherein the spray head has a plurality of guide elements forming channels and the central deflector surface is operable to direct washing solution into the channels.

17. The dishwasher as claimed in claim 15, wherein the central deflector surface is substantially conical in shape.

18. The dishwasher as claimed in claim 12, wherein the spray head is substantially rotationally symmetrical.

19. The dishwasher as claimed in claim 12, wherein the cage is attached to the hydraulic system via a snap-action connection.

20. A top spray device comprising:
a rotatable spray head, the spray head being operable to receive washing solution supplied via a free path which itself is supplied with the washing solution by a hydraulic system of a dishwasher that includes a basket for items to be washed, the rotatable spray head being positionable above the basket for items to be washed; and
a retaining element for attaching the spray head to the hydraulic system of the dishwasher.

21. A spray head for a top spray device, the spray head comprising:
a washing solution receiving component operable to receive washing solution supplied via a free path which itself is supplied with the washing solution by a hydraulic system of a dishwasher that includes a basket for items to be washed and a retaining element for attaching the spray head to the hydraulic system of the dishwasher at a position in which the spray head is above the basket for items to be washed; and
a rotating component operable to rotate during a flow of washing solution through the spray head.

22. A cage for a top spray device, the cage comprising:
a retaining element for attaching a rotatable spray head of a top spray device to the hydraulic system of a dishwasher in a position in which the rotatable spray head can receive washing solution supplied via a free path which itself is supplied with the washing solution by the hydraulic system of the dishwasher, the retaining element retaining the rotatable spray head of the top spray device above a basket for items to be washed.
